(19) United States
(12) Patent Application Publication
(10) Pub. No.: US 2020/0189524 A1
(43) Pub. Date: Jun. 18, 2020

(54) Wiper System

(71) Applicant: Waymo LLC, Mountain View, CA (US)

(72) Inventors: Seth Gilbertson, Dublin, CA (US); Alex Khaykin, San Francisco, CA (US)

(73) Assignees: Waymo LLC, Mountain View, CA (US); Waymo LLC, Mountain View, CA (US)

(21) Appl. No.: 16/217,444

(22) Filed: Dec. 12, 2018

(51) Int. Cl. B60S 1/08; B60S 1/44

(52) U.S. Cl. CPC B60S 1/0818; B60S 1/44; B60S 1/0814

(57) ABSTRACT

The technology relates to a wiper systems. For instance, a system may include a sensor including a sensor housing and a housing window in the sensor housing. The system may also include a rotating drive mechanism. A first portion of the rotating drive mechanism is positioned adjacent to a top of the housing window. The system also includes a plurality of pulleys, and the rotating drive mechanism may be wrapped around at least a portion of the pulleys. The system also includes a wiper attached to the rotating drive mechanism and a motor. The motor may be configured to rotate at least one of the pulleys in order to cause at least the first portion of the rotating drive mechanism to rotate in a first direction. As a result, the wiper may move across the housing window from an initial position to a second position in order to move contaminants on the housing window.

### BACKGROUND

Various types of vehicles, such as cars, trucks, motorcycles, busses, boats, airplanes, helicopters, lawn mowers, recreational vehicles, amusement park vehicles, farm equipment, construction equipment, trams, golf carts, trains, trolleys, etc., may be equipped with various types of sensors in order to detect objects in the vehicle's environment. For example, vehicles, such as autonomous vehicles, may include such LIDAR, radar, sonar, camera, or other such imaging sensors that scan and record data from the vehicle's environment. Sensor data from one or more of these sensors may be used to detect objects and their respective characteristics (position, shape, heading, speed, etc.).

However, these vehicles are often subjected to environmental elements such as rain, snow, dirt, etc., which can cause a buildup of debris and contaminants on these sensors. Typically, the sensors include a cover to protect the internal sensor components of the sensors from the debris and contaminants, but over time, the cover itself may become dirty. As such, the functions of the sensor components may be impeded as signals transmitted and received by the internal sensor components are blocked by the debris and contaminants.

### BRIEF SUMMARY

One aspect of the disclosure provides a system. The system includes a sensor including a sensor housing, a housing window in the sensor housing, and a rotating drive mechanism. A first portion of the rotating drive mechanism is positioned adjacent to the housing window. The system also includes a plurality of pulleys, and the rotating drive mechanism is wrapped around at least a portion of each one of the plurality of pulleys. The system also includes a wiper attached to the rotating drive mechanism and a motor. The motor is configured to rotate at least one of the pulleys of the plurality of pulleys in order to cause at least the first portion of the rotating drive mechanism to rotate in a first direction, and upon the first portion of the rotating drive mechanism rotating in the first direction, the wiper moves across the housing window from an initial position to a second position in order to move contaminants on the housing window.

In one example, the motor is configured to rotate the at least one of the pulleys in order to cause at least the first portion of the rotating drive mechanism to rotate in a second direction opposite of the first direction, and upon the first portion of the rotating drive mechanism rotating in the second direction, the wiper moves across the housing window from the second position towards the initial position in order to move contaminants on the housing window. In another example, the plurality of pulleys includes at least two pulleys. In another example, the plurality of pulleys includes at least three pulleys. In another example, the sensor includes an internal sensor component having a field of view, and the wiper is configured to move the contaminants out of the field of view. In another example, the plurality of pulleys includes four pulleys, and each pulley of the plurality of pulleys is arranged at a corner of the housing window such that the rotating drive mechanism is arranged around outer edges of the housing window. In another example, the rotating drive mechanism is a belt. In another example, the rotating drive mechanism is a chain. In another example, the rotating drive mechanism is a rope. In another example, the system also includes a linear slide, and the system also includes a linear bearing mounted to the linear slide. In this example, the wiper is attached to the linear bearing and the linear bearing is in contact with the first portion of the rotating drive mechanism and configured to slide along the linear slide as the first portion of the rotating drive mechanism moves. In another example, the system also includes a second wiper attached to the rotating drive mechanism. In this example, the second wiper is attached to the rotating drive mechanism adjacent to a top of the housing window and the wiper is attached to the rotating drive mechanism adjacent to a bottom of the housing window. In this example, the wiper and the second wiper are attached to the rotating drive mechanism such that rotation of the at least one of the plurality of pulleys in the first direction causes the wiper and the second wiper to move away from one another. In addition, the wiper and the second wiper are attached to the rotating drive mechanism such that rotation of the at least one of the plurality of pulleys in the first direction causes the wiper and the second wiper to move towards one another. Alternatively, the wiper and the second wiper are attached to the rotating drive mechanism such that rotation of the at least one of the plurality of pulleys in the first direction causes the wiper and the second wiper to move in a same direction. In addition or alternatively, the wiper is attached to the rotating drive mechanism between a first pair of the plurality of pulleys. In this example, the second wiper is attached to the rotating drive mechanism between a second pair of the plurality of pulleys, the first pair being different from the second pair. In another example, the system also includes a sensor configured to detect the contaminants on the housing window. In addition, the system also includes a computing device configured to receive sensor data from the sensor and cause the motor to rotate the at least one of the plurality of pulleys. In addition, the system also includes a vehicle configured to use the sensor to operate in an autonomous driving mode.

### BRIEF DESCRIPTION OF THE DRAWINGS

FIG. 1 is a functional diagram of an example vehicle in accordance with aspects of the disclosure.

FIG. 2 is an example external view of a vehicle in accordance with aspects of the disclosure.

FIG. 3 is an example view of a wiper system in accordance with aspects of the disclosure.

FIG. 4 is an example top-down cutaway view of a sensor housing and internal sensor components in accordance with aspects of the disclosure.

FIG. 5 is an example wiper in accordance with aspects of the disclosure.

FIGS. 6A and 6B are example views of a wiper system in accordance with aspects of the disclosure.

FIG. 7 is an example view of a wiper system in accordance with aspects of the disclosure.

FIG. 8 is an example view of a wiper system in accordance with aspects of the disclosure.

FIG. 9 is an example view of a wiper system in accordance with aspects of the disclosure.

FIG. 10 is an example view of a wiper system in accordance with aspects of the disclosure.

FIG. 11 is an example view of a screw drive for a wiper system in accordance with aspects of the disclosure.

### DETAILED DESCRIPTION

### Overview

The technology relates to clearing sensors of debris and contaminants to assure adequate operation. For instance, a sensor may include a sensor housing to protect the internal sensor components from the debris and refuse (collectively, referred to herein as contaminants), but the housing itself may become dirty over time. As such, the functions of the internal sensor components may be impeded as signals transmitted and received by the internal sensor components may be blocked by the contaminants.

To address these issues, contaminants may be cleared from a sensor housing of a sensor by wiping the sensor housing with a wiper of a wiper system. The wiper system may include two wipers may be moved along a sensor housing such that the wiper blades of the wipers loosen, pull, and push away the contaminants built up on the sensor housing.

The sensors may be comprised of a sensor housing, a housing window, and one or more internal sensor components positioned within the sensor housing. The cover of the sensor may include a housing window through which the internal sensor components may transmit and receive signals. The internal sensor components may transmit and receive one or more signals through the housing window of the sensor. In this regard, the internal sensor components may include one or more imaging sensors such as LIDAR, radar, sonar, camera, or other such imaging sensors positioned within the cover of the sensor. For instance, two or more cameras may be configured to capture frames which include data corresponding to the sensor's surroundings. As such, the housing window may be configured to provide sufficient area for each of the camera's field of view to pass through the housing window unimpeded. Each camera may be configured to capture frames of data corresponding with the field of view of the respective camera at certain time intervals.

The wipers of the wiper system may be comprised of a wiper blade, a wiper support, and a wiper arm. The wiper blade may be connected to the wiper support, and the wiper arm may connect the wiper support to a rotating drive mechanism. The rotating drive mechanism may include a motor and linear slide on which linear bearings are positioned. The linear bearings may be configured to slide along the linear slide. The rotating drive mechanism may also include a rotating drive mechanism which may be in contact with the linear bearings and configured to move the linear bearings along the linear slide as the rotating drive mechanism rotates around the collection of pulleys. The motor may be configured to rotate one or more of the pulleys, and in turn, rotate the rotating drive mechanism around the pulleys. The rotating drive mechanism may be configured to move contaminants out of the fields of view of the imaging sensors and maintain clear fields of view for each of the imaging sensors through the housing window. In some instances, the rotating drive mechanism and wipers may even wipe the housing window free of contaminants.

The features described herein may allow for continued use of a sensor even when the sensor's cover becomes dirty. By doing such, the sensor may continue operation without interruption or the need for an individual to manually clean the sensor, as the wiper may continually clean the sensor housing or clean the sensor housing when needed. As such, the vehicle may continually operate in environments which produce a lot of contaminants, such as construction sites or off-road locations. Moreover, the features described herein may allow imaging sensors to provide sufficient imaging data when the sensor housing is being cleared.

### Example Systems

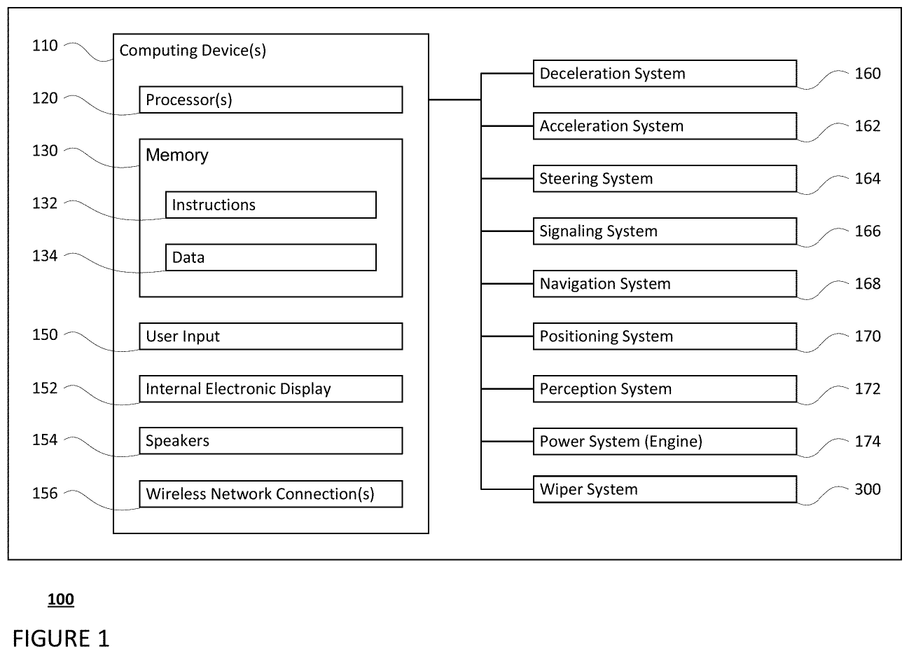

As shown in FIG. 1, a vehicle 100 in accordance with one aspect of the disclosure includes various components. While certain aspects of the disclosure are particularly useful in connection with specific types of vehicles, the vehicle may be any type of vehicle including, but not limited to, cars, trucks, motorcycles, busses, recreational vehicles, etc. The vehicle may have one or more computing devices, such as computing device 110 containing one or more processors 120, memory 130 and other components typically present in general purpose computing devices.

The memory 130 stores information accessible by the one or more processors 120, including instructions 132 and data 134 that may be executed or otherwise used by the processor 120. The memory 130 may be of any type capable of storing information accessible by the processor, including a computing device-readable medium, or other medium that stores data that may be read with the aid of an electronic device, such as a hard-drive, memory card, ROM, RAM, DVD or other optical disks, as well as other write-capable and read-only memories. Systems and methods may include different combinations of the foregoing, whereby different portions of the instructions and data are stored on different types of media.

The instructions 132 may be any set of instructions to be executed directly (such as machine code) or indirectly (such as scripts) by the processor. For example, the instructions may be stored as computing device code on the computing device-readable medium. In that regard, the terms “instructions” and “programs” may be used interchangeably herein. The instructions may be stored in object code format for direct processing by the processor, or in any other computing device language including scripts or collections of independent source code modules that are interpreted on demand or compiled in advance. Functions, methods and routines of the instructions are explained in more detail below.

The data 134 may be retrieved, stored or modified by processor 120 in accordance with the instructions 132. As an example, data 134 of memory 130 may store predefined scenarios. A given scenario may identify a set of scenario requirements including a type of object, a range of locations of the object relative to the vehicle, as well as other factors such as whether the autonomous vehicle is able to maneuver around the object, whether the object is using a turn signal, the condition of a traffic light relevant to the current location of the object, whether the object is approaching a stop sign, etc. The requirements may include discrete values, such as “right turn signal is on” or “in a right turn only lane”, or ranges of values such as “having an heading that is oriented at an angle that is 20 to 60 degrees offset from a current path of vehicle 100.” In some examples, the predetermined scenarios may include similar information for multiple objects.

The one or more processor 120 may be any conventional processors, such as commercially available CPUs. Alternatively, the one or more processors may be a dedicated device such as an ASIC or other hardware-based processor. Although FIG. 1 functionally illustrates the processor, memory, and other elements of computing device 110 as being within the same block, it will be understood by those of ordinary skill in the art that the processor, computing device, or memory may actually include multiple processors, computing devices, or memories that may or may not be stored within the same physical housing. As an example, internal electronic display 152 may be controlled by a dedicated computing device having its own processor or central processing unit (CPU), memory, etc. which may interface with the computing device 110 via a high-bandwidth or other network connection. In some examples, this computing device may be a user interface computing device which can communicate with a user's client device. Similarly, the memory may be a hard drive or other storage media located in a housing different from that of computing device 110. Accordingly, references to a processor or computing device will be understood to include references to a collection of processors or computing devices or memories that may or may not operate in parallel.

Computing device 110 may all of the components normally used in connection with a computing device such as the processor and memory described above as well as a user input 150 (e.g., a mouse, keyboard, touch screen and/or microphone) and various electronic displays (e.g., a monitor having a screen or any other electrical device that is operable to display information). In this example, the vehicle includes an internal electronic display 152 as well as one or more speakers 154 to provide information or audio visual experiences. In this regard, internal electronic display 152 may be located within a cabin of vehicle 100 and may be used by computing device 110 to provide information to passengers within the vehicle 100. The vehicle may also include one or more wireless network connections 156 to facilitate communicates with devices remote from the vehicle and/or between various systems of the vehicle.

In one example, computing device 110 may be an autonomous driving computing system incorporated into vehicle 100. The autonomous driving computing system may capable of communicating with various components and systems of the vehicle, for instance, wirelessly (via wireless network connections 156) and/or a wired connection (such as a controller area network bus or other communication bus). For example, returning to FIG. 1, computing device 110 may be in communication with various systems of vehicle 100, such as deceleration system 160 (for controlling braking of the vehicle), acceleration system 162 (for controlling acceleration of the vehicle), steering system 164 (for controlling the orientation of the wheels and direction of the vehicle), signaling system 166 (for controlling turn signals), navigation system 168 (for navigating the vehicle to a location or around objects), positioning system 170 (for determining the position of the vehicle), perception system 172 (for detecting objects in the vehicle's environment), and power system 174 (for example, a battery and/or gas or diesel powered engine) in order to control the movement, speed, etc. of vehicle 100 in accordance with the instructions 132 of memory 130 in an autonomous driving mode which does not require or need continuous or periodic input from a passenger of the vehicle. Again, although these systems are shown as external to computing device 110, in actuality, these systems may also be incorporated into computing device 110, again as an autonomous driving computing system for controlling vehicle 100. In addition or alternatively, each of these system may include one or more computing devices having processors and memory, configured the same as or similarly to processors 120 and memory 130 of computing devices 110 in order to enable the functionalities of these systems as described here.

The computing device 110 may control the direction and speed of the vehicle by controlling various components. By way of example, computing device 110 may navigate the vehicle to a destination location completely autonomously using data from the map information and navigation system 168. Computing devices 110 may use the positioning system 170 to determine the vehicle's location and perception system 172 to detect and respond to objects when needed to reach the location safely. In order to do so, computing devices 110 may cause the vehicle to accelerate (e.g., by increasing fuel or other energy provided to the engine by acceleration system 162), decelerate (e.g., by decreasing the fuel supplied to the engine, changing gears, and/or by applying brakes by deceleration system 160), change direction (e.g., by turning the front or rear wheels of vehicle 100 by steering system 164), and signal such changes (e.g., by lighting turn signals of signaling system 166). Thus, the acceleration system 162 and deceleration system 160 may be a part of a drivetrain that includes various components between an engine of the vehicle and the wheels of the vehicle. Again, by controlling these systems, computing devices 110 may also control the drivetrain of the vehicle in order to maneuver the vehicle autonomously.

As an example, computing device 110 may interact with deceleration system 160 and acceleration system 162 in order to control the speed of the vehicle. Similarly, steering system 164 may be used by computing device 110 in order to control the direction of vehicle 100. For example, if vehicle 100 configured for use on a road, such as a car or truck, the steering system may include components to control the angle of wheels to turn the vehicle. Signaling system 166 may be used by computing device 110 in order to signal the vehicle's intent to other drivers or vehicles, for example, by lighting turn signals or brake lights when needed.

Navigation system 168 may be used by computing device 110 in order to determine and follow a route to a location. In this regard, the navigation system 168 and/or data 134 may store map information, e.g., highly detailed maps that computing devices 110 can use to navigate or control the vehicle 100. As an example, these maps may identify the shape and elevation of roadways, lane markers, intersections, crosswalks, speed limits, traffic signal lights, buildings, signs, real time or historical traffic information, vegetation, or other such objects and information. The lane markers may include features such as solid or broken double or single lane lines, solid or broken lane lines, reflectors, etc. A given lane may be associated with left and right lane lines or other lane markers that define the boundary of the lane. Thus, most lanes may be bounded by a left edge of one lane line and a right edge of another lane line. As noted above, the map information may store known traffic or congestion information and/or and transit schedules (train, bus, etc.) from a particular pickup location at similar times in the past. This information may even be updated in real time by information received by the computing devices 110.

As an example, the detailed map information may include one or more roadgraphs or graph networks of information such as roads, lanes, intersections, and the connections between these features. Each feature may be stored as graph data and may be associated with information such as a geographic location and whether or not it is linked to other related features, for example, a stop sign may be linked to a road and an intersection, etc. In some examples, the associated data may include grid-based indices of a roadgraph to allow for efficient lookup of certain roadgraph features.

The perception system 172 also includes one or more components for detecting objects external to the vehicle such as other vehicles, obstacles in the roadway, traffic signals, signs, trees, etc. For example, the perception system 172 may include one or more LIDAR sensors, sonar devices, radar units, cameras and/or any other detection devices that record data which may be processed by computing devices 110. The sensors of the perception system may detect objects and their characteristics such as location, orientation, size, shape, type (for instance, vehicle, pedestrian, bicyclist, etc.), heading, speed, acceleration, rate of change of acceleration, deceleration, rate of change of deceleration, etc. The raw data from the sensors and/or the aforementioned characteristics can be quantified or arranged into a descriptive function, vector, and or bounding box and sent for further processing to the computing devices 110 periodically and continuously as it is generated by the perception system 172.

As discussed in further detail below, computing devices 110 may use the positioning system 170 to determine the vehicle's location and perception system 172 to detect and respond to objects when needed to reach the location safely.

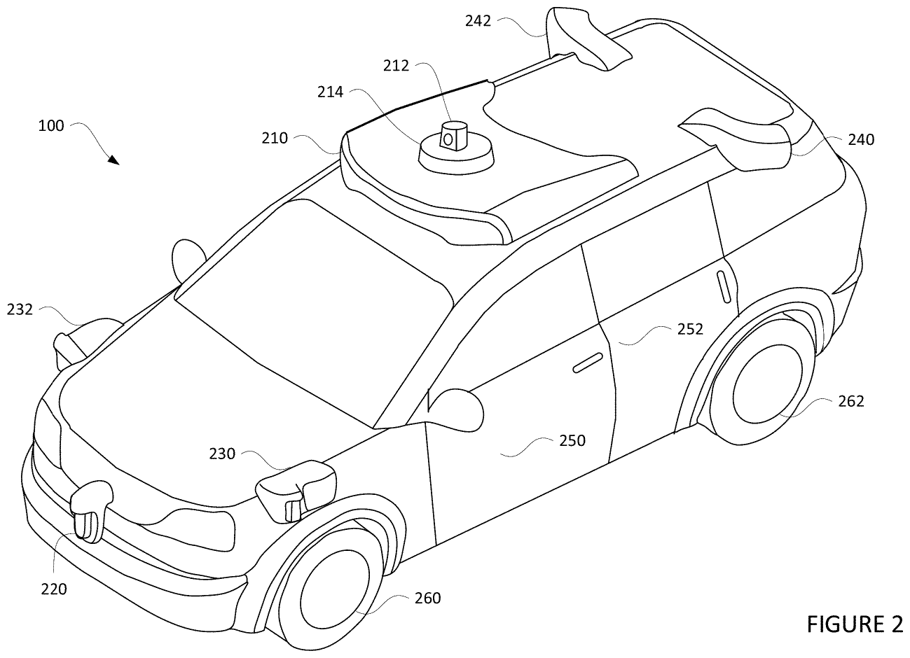

For instance, FIG. 2 is an example external view of vehicle 100. In this example, roof-top housing 210 and housings 212, 214 may include a LIDAR sensor as well as various cameras and radar units. In addition, housing 220 located at the front end of vehicle 100 and housings 230, 232 on the driver's and passenger's sides of the vehicle may each store a LIDAR sensor. For example, housing 230 is located in front of driver door 250. Vehicle 100 also includes housings 240, 242 for radar units and/or cameras also located on the roof of vehicle 100. Additional radar units and cameras (not shown) may be located at the front and rear ends of vehicle 100 and/or on other positions along the roof or roof-top housing 210. Vehicle 100 also includes many features of a typical passenger vehicle such as doors 250, 252, wheels 260, 262, etc.

### Example Wiper Systems

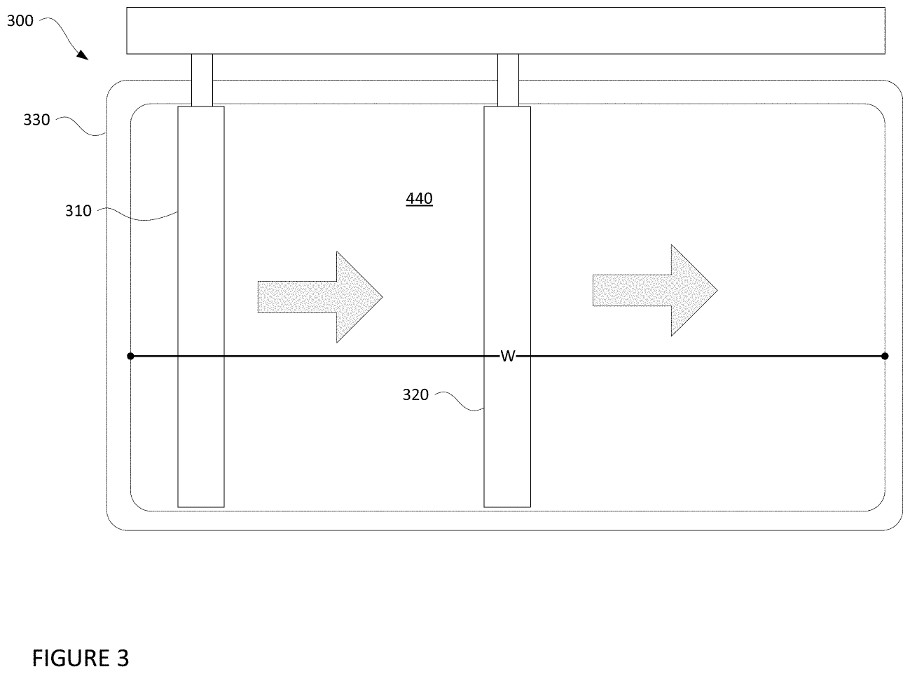

Returning to FIG. 1, the vehicle 100 may also include a wiper system 300. The wiper system 300 may be configured to receive commands from the computing devices 110, for instance via a wired or wireless connection. As shown in FIG. 3, the wiper system 300 may include two wipers 310, 320 that may be connected to along a sensor housing 330 of a sensor such that the wiper blades of the wipers loosen, pull, and push away the contaminants built up on the sensor housing.

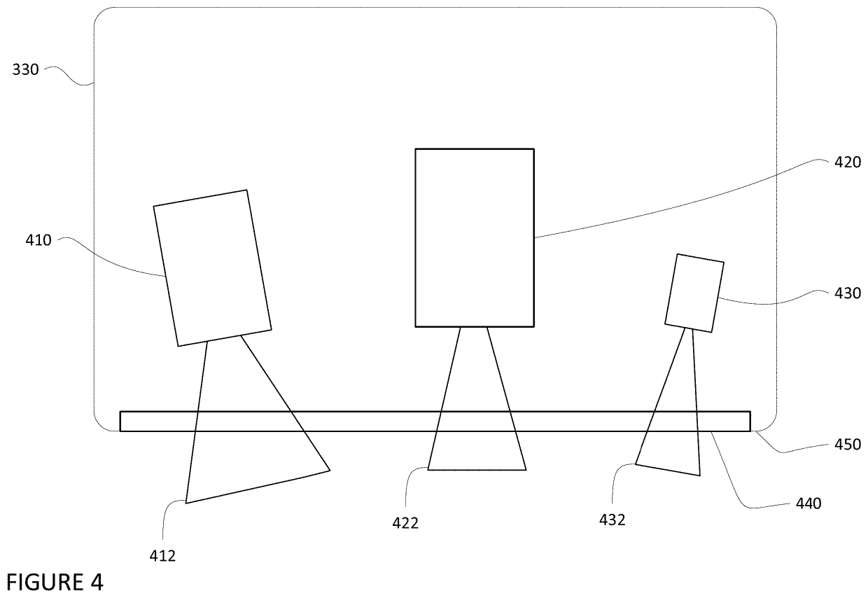

The sensor may be comprised of the sensor housing, a housing window, and one or more internal sensor components positioned within the sensor housing. For instance, as shown in FIG. 4, internal sensor components 410, 420, 430 may be positioned within the interior of the sensor housing 330 and behind a housing window 440. Although the sensor housing 330 is shown as being of a rectangular shape having rounded corners, the sensor housing may be of any shape. The sensor housing may be comprised of materials such as plastic, glass, polycarbonate, polystyrene, acrylic, polyester, etc.

The sensor may be located internally or externally from a vehicle. For an example, sensor housing 330 may represent any of the sensor housings of the perception system 172, such as roof-top housing 210, housing 212, housing 214, housing 220, and housings 230, 232.

The internal sensor components 410, 420, 430 may transmit and receive signals through the housing window. For instance, as further shown in the top-down, cutaway view of sensor housing 330 of FIG. 4, the housing window 440 is incorporated into a side wall 450 of the sensor housing 330. As with the sensor housing 330, although the housing window 440 is shown as rectangular with rounded corner, various other shapes may also be used for the housing window. The housing window 440 may be composed of the same, or different, material or materials as the sensor housing or may be other materials or configurations such as IR transparent materials, radomes, etc. In some instances the entire sensor housing, or a large portion of the sensor housing, may be penetrable by the signals transmitted and received by the internal sensor components, thereby allowing the entire sensor housing to operate as a housing window.

The internal sensor components 410, 420, 430 may transmit and receive one or more signals through the housing window of the sensor. In this regard, the internal sensor components 410, 420, 430 may include one or more imaging sensors such as LIDAR, radar, sonar, camera, or other such imaging sensors positioned within the cover of the sensor. For instance, as shown of FIG. 4, the internal sensor components 410, 420, 430 may be three stationary cameras positioned such that signals output and received by the cameras pass through the housing window. Although three stationary cameras are shown as being within the sensor housing, any combination of stationary or rotating imaging sensors may be used.

The cameras may be configured to capture frames which include data corresponding to the sensor's surroundings. For instance, as shown in FIG. 4, each of the internal sensor components 410, 420, 430 may have a field of view 412, 422, 432 within which the respective internal sensor component is able to capture sensor data. In the example of cameras, the internal sensor components 410, 420, 430 may capture images. In order to capture a full image, each camera may require a certain amount of space, such as between 10 and 75 mm, or more or less, of unimpeded space on the housing window corresponding to the respective camera's field of view. As such, in this example, the width (w) of the housing window 440 may be around 400 mm, or more or less. In this regard, the housing window 440 may be configured to provide sufficient area for each of the fields of view 412, 422, 432 to be unimpeded by other components of the sensor and/or the wipers.

Each internal sensor component may be configured to capture sensor data corresponding with the field of view of the respective internal sensor component at certain time intervals. For instance, in the example of cameras, each camera may capture a frame every 100 ms, or more or less.

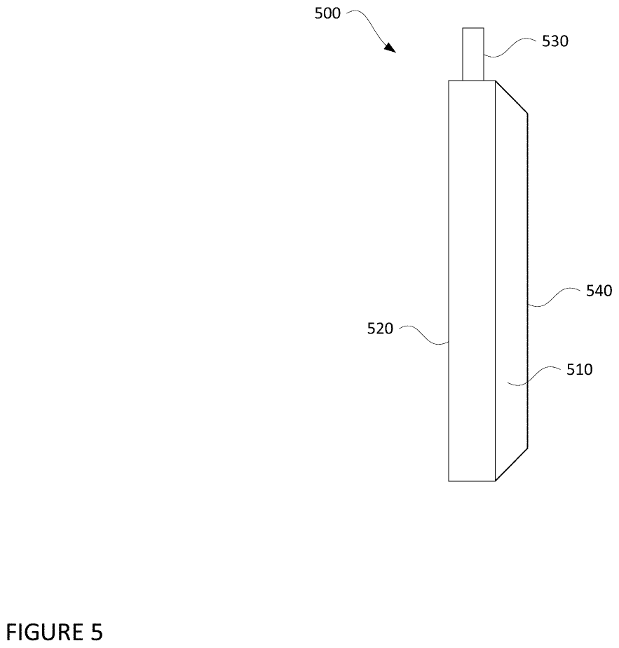

The wipers 310, 320 of the wiper system may be comprised of a wiper blade, a wiper support 350, 352, and a wiper arm 312, 322. As noted above, the wiper arm may connect the wiper support to the drive system 340, discussed herein. The wiper blade may be connected to the wiper support. For instance, as shown in FIG. 5, a wiper 500, which may correspond to either or both of wipers 310, 320, is shown having a wiper blade 510, wiper support 520, and wiper arm 530. The wiper blade 510 may be comprised of materials capable of moving and removing contaminants, such as rubber (for example, buna, ethylene propylene diene monomer (EPDM), silicone, etc.) or plastic (for example, urethane, polyethylene, etc.). The wiper blade 510 may also be comprised of a solid or sponge-like foam or fabric, for example, woven fabric, felted fabric, etc.). In some embodiments each wiper 500, 310, 320 may include multiple wiper blades, supports, and/or arms.

As further shown in FIG. 5, an edge 540 of the wiper blade 510 may be constructed such that the edge extends horizontally outwards from the wiper support 520. The width of the wiper blade 510 may be greater than the distance from the edge of the wiper support 520 to the housing window 440 when the wiper 500 (or wiper 310 or wiper 320) is positioned next to the sensor housing 330. As an example, the wiper blade may be 15-20 mm wide, or more or less.

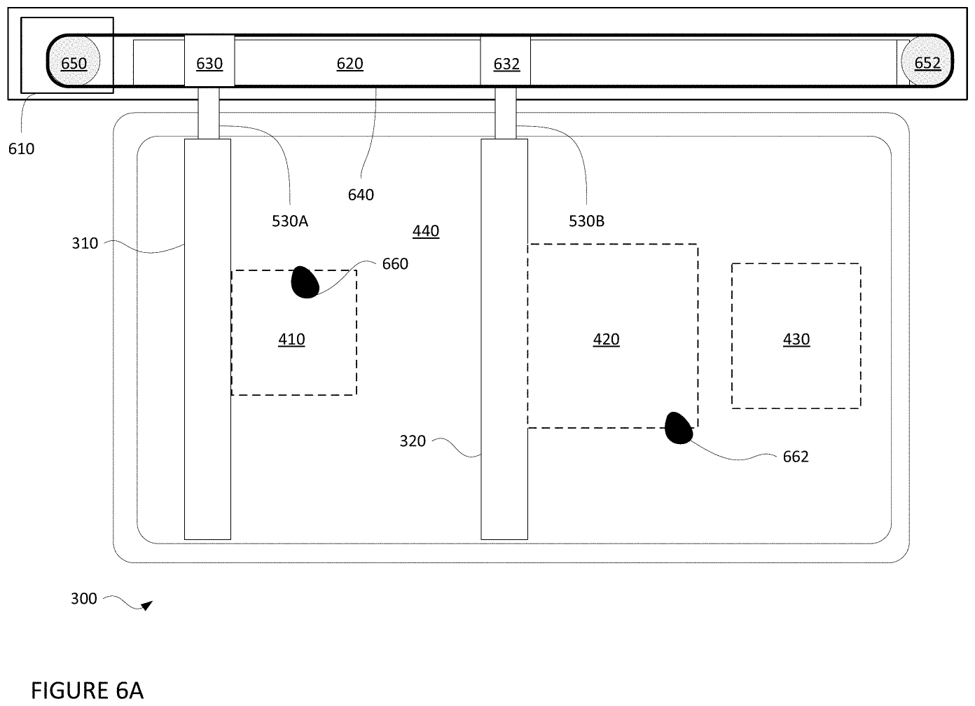

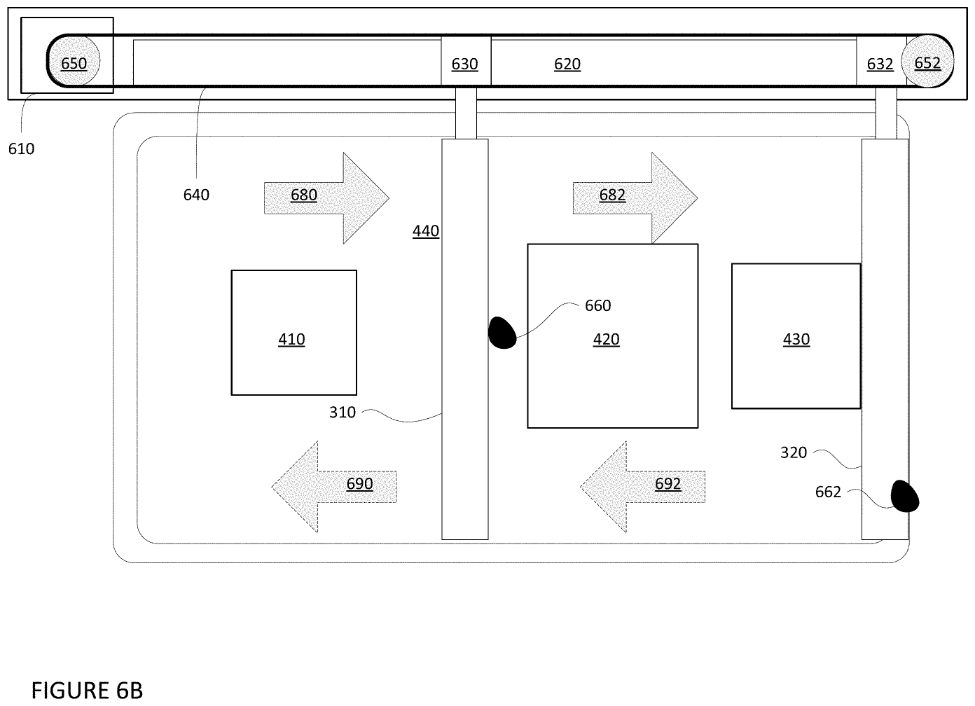

Turning to FIG. 6A, in addition to wipers, the wiper system 300 may include a drive system 340 positioned at or adjacent to a top 446 of the housing window 440. Alternatively, the drive system 340 may be positioned at or adjacent to a bottom 448 of the housing window 440 or one of the lateral edges 442, 444 of the housing window.

The drive system 340 may include a rotating drive mechanism. The rotating drive mechanism may include a motor 610 and linear slide 620 on which linear bearings 630, 632 are positioned. The linear bearings may be configured to slide along the linear slide, via one or more wheels, bearings, etc. The rotating drive mechanism may also include a rotating drive mechanism 640 such as a belt, rope, chain, or the like wrapped around a portion of each of a collection of pulleys 650, 652. The rotating drive mechanism may be in contact with the linear bearings and configured to move the linear bearings along the linear slide as the rotating drive mechanism rotates around the collection of pulleys.

The motor may be configured to rotate one or more of the pulleys 650, 652, and in turn, rotate the rotating drive mechanism 640 around the pulleys. The linear bearings 630, 632 may be in contact with the rotating drive mechanism 640 may be forced along the linear slide due the rotation force of the rotating drive mechanism around the collection of pulleys. In some instances, the rotating drive mechanism may be sealed within a housing to prevent contaminants from reaching the rotating drive mechanism. Alternatively, the rotating drive mechanism may be open in order to prevent materials such as snow and ice from becoming trapped and interfering with the rotating drive mechanism.

The rotating drive mechanism and wipers may be configured to move contaminants out of the fields of view of the imaging sensors and maintain a clear fields of view for each of the internal sensor components 410, 420, 430 (depicted in dashed line behind the housing window 440 in FIGS. 6A and 6B) through the housing window. In some instances, the rotating drive mechanism and the wipers may even wipe the housing window free of contaminants. In this regard, and as shown in FIGS. 6A and 6B each of the wipers 310, 320 is attached to a respective one of the linear bearings 630, 632 via respective wiper arms 312, 322 (corresponding to wiper arm 530 of FIG. 5).

In use, the motor 610 may cause the pulley 650 and or pulley 652 to rotate, for instance clockwise or counter clockwise. This rotation may cause the rotating drive mechanism 640 to move around the pulleys in the same direction of rotation of the pulleys. In turn, the movement of the rotating drive mechanism 640 may pull the linear bearings 630, 632 along the linear slide 620. In turn, the movement of the linear bearings 630, 632 may cause the wipers 310, 320 to move from a first position (shown in FIG. 6A) to a second position (shown in FIG. 6B) in a direction of arrows 680, 682. By doing such, the wipers may move (e.g. loosen, pull, and/or push away) the contaminants 660, 662 built up on the housing window 440 to a location outside of the fields of view of the internal sensor components 420, 420, 430. In other words, this motion may move, and in some cases clear, contaminants on the housing window.

Thereafter, the motor 610 may reverse direction, thereby causing the rotating drive mechanism 640 to return the wipers 310, 320 to the first position, for instance, by moving in the direction of arrows 690, 692. This motion may move, and in some cases clear, contaminants on the housing window.

In some instances, more than one motor may be connected to one or more of the pulleys. For instance, motor 610 may drive pulley 650 while a second motor, not shown, may drive pulley 652. In some examples, the motor may be connected to a pulley via a gear reduction drive in order to reduce the rotation speed of the pulley relative to the rotation of the motor.

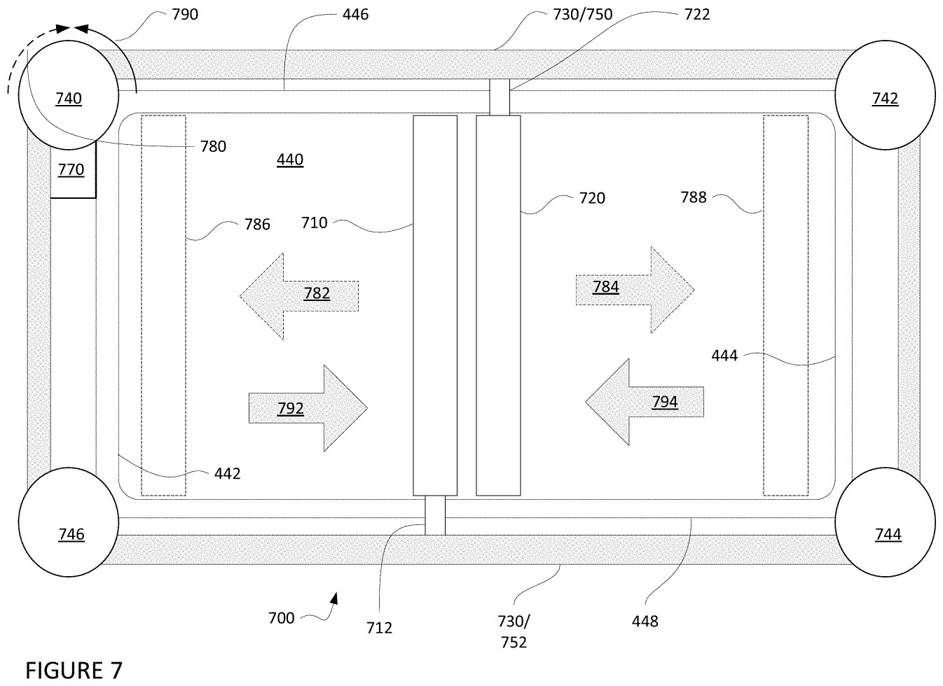

In another example, two wipers may be attached via a wiper arm to a rotating drive mechanism wrapped around a portion of a plurality of pulleys and positioned around a housing window. For instance, as shown in example wiper system 700, FIG. 7, wipers 710, 720, which may correspond to wipers 310, 320, 500, are attached to wiper arms 712, 722, which may correspond to wiper arms 530, 312, 322. The wiper arms are attached to a rotating drive mechanism 730. The wipers may actually be connected to a linear bearing, similar to linear bearings 630, 632, which is connected to the rotating drive mechanism. As with rotating drive mechanism 640, the rotating drive mechanism 730 may be a belt, rope, chain, or the like wrapped around at least a portion of a collection of pulleys.

For instance, the rotating drive mechanism 730 is wrapped around at least a portion of a collection of pulleys 740, 742, 744, 746 such that a portion 750 of the rotating drive mechanism is positioned in across the top 446 and another portion 752 of the rotating drive mechanism is positioned in across the bottom 448. For an example, as shown in FIG. 7, portions 750 and 752 may be arranged parallel to one another. One of the wipers, here wiper 710 may be attached to the rotating drive mechanism 730 via wiper arm 712 at a position below the bottom 448, and another of the wipers, here wiper 720, may be attached to the rotating drive mechanism via wiper arm 722 at a position above the top 446.

In operation, a motor 770 may drive one of the pulleys, here pulley 740, in a first direction, depicted by arrow 780. This may cause causing the rotating drive mechanism 730, and the other pulleys 742, 744, 746 to rotate in the first direction. In this regard, a friction force generated between the pulley 740 being rotated by the motor 770 and the rotating drive mechanism 730 may cause the other pulleys to rotate as the rotating drive mechanism 730 is rotated by the pulley rotated by the motor. By doing such, the wipers 710, 720 may both move away from a center of the housing window 440 and towards the lateral edges 442, 444 of the housing window in the directions of arrows 782, 784, respectively. Eventually, wiper 710 may be positioned in the dashed line area 786, wiper 720 may be positioned in the dashed line area 788. As such, the wiper blades may be moved away from one another towards an adjacent lateral edge of the housing window. This motion may move, and in some cases clear, contaminants on the housing window. As an example, the wipers may each move around 180-200 mm, or more or less, away from the center of the housing window when the housing window is around 400 mm.

Thereafter the motor 770 may drive one of the pulleys, here pulley 740, in a second direction, depicted by arrow 790. This may cause causing the rotating drive mechanism 730, and the other pulleys 742, 744, 746 to rotate in the second direction. In this regard, a friction force generated between the pulley 740 being rotated by the motor 770 and the rotating drive mechanism 730 may cause the other pulleys to rotate as the rotating drive mechanism 730 is rotated by the pulley rotated by the motor. By doing such, the wipers 710, 720 may both move towards from a center of the housing window 440 and away from the lateral edges 442, 444 of the housing window in the directions of arrows 792, 794, respectively. Eventually, wipers 710, 720 may be positioned as shown in FIG. 7. As such, the wiper blades may be moved away from one another towards an adjacent lateral edge of the housing window. This motion may move, and in some cases clear, contaminants on the housing window. Again, as an example, the wipers may each move around 180-200 mm, or more or less, towards the center of the housing window when the housing window is around 400 mm.

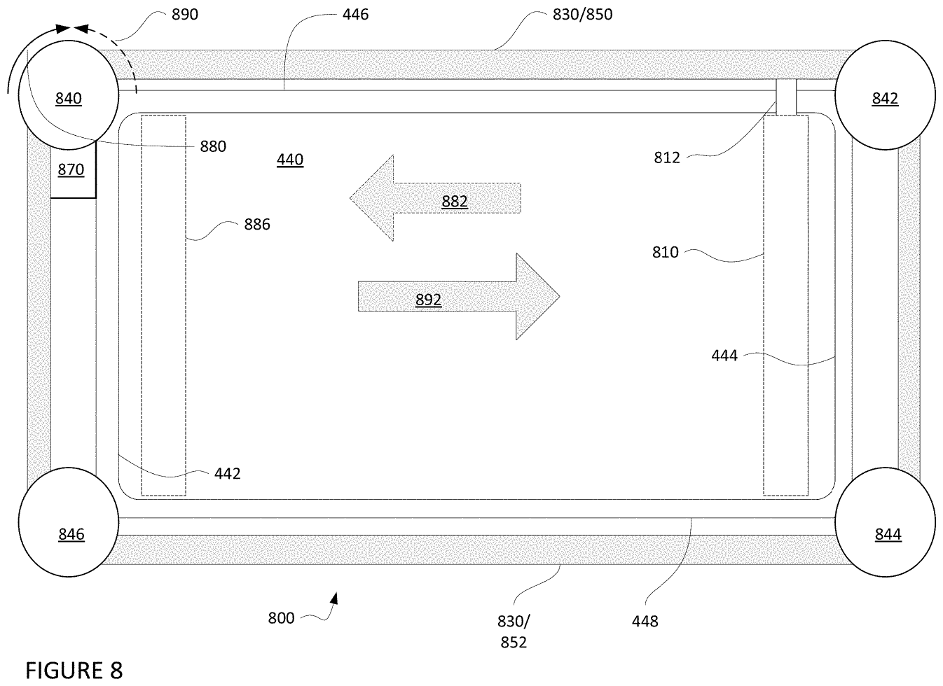

In some instances, only a single wiper may be attached to the rotating drive mechanism. For instance, and as shown in the example wiper system 800 of FIG. 8, a single wiper 810, corresponding to any of wipers 310, 320, 500, 710, 720 may be attached via a wiper arm 812 (corresponding to any of wiper arms 530, 312, 322, 712, 722) to a rotating drive mechanism configured similarly to the example of FIG. 7. For instance, rotating drive mechanism 830 may correspond to rotating drive mechanism 730, collection of pulleys 840, 842, 844, 846, may correspond to the collection of pulleys 740, 742, 744, 746, and portions 850 and 852 may correspond to portions 750 and 752. As with rotating drive mechanisms 640 and 730, the rotating drive mechanism 830 may be a belt, rope, chain, or the like wrapped around a collection of pulleys. The wiper 810 may be connected to the rotating drive mechanism via the wiper arm 812 and/or may be connected to a linear bearing, similar to linear bearings 630, 632, which is connected to the rotating drive mechanism.

As with the example of FIG. 8, the rotating drive mechanism 830 is wrapped around at least a portion of the collection of pulleys 840, 842, 844, 846 such that a portion 850 of the rotating drive mechanism is positioned in across a top 446 of the housing window 440 and another portion 852 of the rotating drive mechanism is positioned in across a bottom 448 of the housing window 440. For an example, as shown in FIG. 8, portions 850 and 852 may be arranged parallel to one another. Wiper 810 may be attached to the rotating drive mechanism 830 via wiper arm 812. In addition, as shown, each of the pulleys is arranged at or adjacent to a respective corner of the housing window 440 such that the rotating drive mechanism is arranged around outer edges of the housing window.

In the example of FIG. 8, the motor 870 may rotate the rotating drive mechanism in a first direction, depicted by arrow 880, such that the wiper 810 moves across the entirety, or about the entirety, of the housing window 440 from an initial position depicted in FIG. 8 to a second position indicated by dashed line area 886. As with the example of FIG. 7, rotation of the pulley 840 by the motor 870 may cause causing the rotating drive mechanism 830, and the other pulleys 842, 844, 846 to rotate in the first direction. In this regard, a friction force generated between the pulley 840 being rotated by the motor 870 and the rotating drive mechanism 830 may cause the other pulleys to rotate. By doing such, the wiper 810 may move in the directions of arrow 882 away from lateral edge 444 towards lateral edge 442 to the second position indicated by dashed line area 886. This motion may move, and in some cases clear, contaminants on the housing window.

Upon the wiper 810 reaching the second position, the motor 870 drive one of the pulleys, here pulley 740, in a second direction, depicted by arrow 890. This may cause causing the rotating drive mechanism 830, and the other pulleys 842, 844, 846 to rotate in the second direction. In this regard, a friction force generated between the pulley 840 being rotated by the motor 870 and the rotating drive mechanism 830 may cause the other pulleys to rotate. By doing such, the wiper 810 may be moved towards the lateral edge 44 and away from the lateral edge 444 in the direction of arrow 892. Eventually, wiper 810 may be positioned as shown in FIG. 8. This motion may move, and in some cases clear, contaminants on the housing window. Although FIG. 8 illustrates the wiper moving across the nearly the entire housing window, the motor 870 may limit the range of motion of the wiper 810 to only portions of the housing window 440.

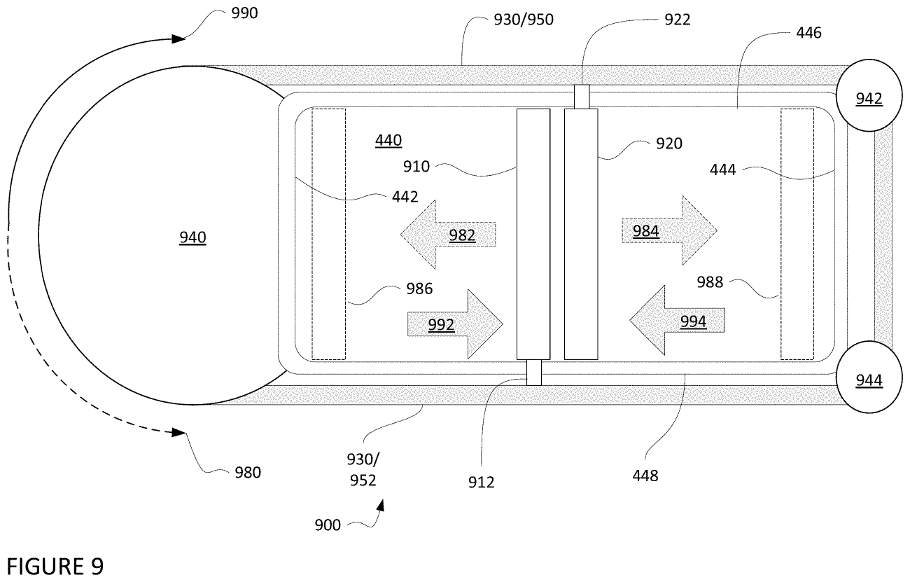

In some instances, a single pulley may be positioned on a side of the housing window in place of a pair of pulleys. For instance, and as shown in the example wiper system 900 FIG. 9, a single pulley 940 may replace a pair of pulleys (for instance, pulleys 840, 846 or pulleys 740, 746) adjacent to lateral edge 442. The single pulley 940 may rotate a rotating drive mechanism 930, which may correspond to any of rotating drive mechanisms 640, 730, 830, around the housing window to push and/or pull one or two wipers 910, 920 (shown in FIG. 9) across the housing window 440. Wipers 910, 920, may correspond to any of wipers 310, 320, 500, 720, 720, 810. A pair of pulleys 942, 946, which may correspond to pulleys 842, 844 or pulleys 742, 744, may be positioned adjacent to an opposite lateral edge, here lateral edge 444. The pulleys 842, 844 may direct the rotating drive mechanism 930 around the lateral edge 444. In some instances, two larger pulleys may be used in place of two pairs of pulleys. For instance, pulleys 942 and 944 may be replaced by a pulley corresponding to pulley 940. The wipers 910, 920 may be connected to the rotating drive mechanism via the wiper arm 912 and/or may be connected to a linear bearing, similar to linear bearings 630, 632, which is connected to the rotating drive mechanism.

As shown in FIG. 9, the rotating drive mechanism 930 is wrapped around at least a portion of a collection of pulleys 940, 942, 944 such that a portion 950 of the rotating drive mechanism is positioned in across a top 446 of the housing window 440 and another portion 952 of the rotating drive mechanism is positioned in across a bottom 448 of the housing window 440. For an example, as shown in FIG. 9, portions 950 and 952 may be arranged parallel to one another. One of the wipers, here wiper 910 may be attached to the rotating drive mechanism 930 via wiper arm 912 at a position below the bottom 448, and another of the wipers, here wiper 920, may be attached to the rotating drive mechanism via wiper arm 922 at a position above the top 446.

A motor (not shown, but which may be configured similarly to any of motors 610, 770, 870) may drive one of the pulleys, here pulley 940, in a first direction, depicted by arrow 980. This may cause causing the rotating drive mechanism 930, and the other pulleys 942, 944, to rotate in the first direction. In this regard, a friction force generated between the pulley 940 being rotated by the motor and the rotating drive mechanism 930 may cause the other pulleys to rotate as the rotating drive mechanism 930 is rotated by the pulley rotated by the motor. By doing such, the wipers 910, 920 may both move away from a center of the housing window 440 and towards the lateral edges 442, 444 of the housing window in the directions of arrows 982, 984, respectively. Eventually, wiper 910 may be positioned in the dashed line area 986, wiper 920 may be positioned in the dashed line area 988. As such, the wiper blades may be moved away from one another towards an adjacent lateral edge of the housing window. This motion may move, and in some cases clear, contaminants on the housing window. As an example, the wipers may each move around 180-200 mm, or more or less, away from the center of the housing window when the housing window is around 400 mm.

Thereafter the motor may drive one of the pulleys, here pulley 940, in a second direction, depicted by arrow 990. This may cause causing the rotating drive mechanism 930, and the other pulleys 942, 944 to rotate in the second direction. In this regard, a friction force generated between the pulley 940 being rotated by the motor and the rotating drive mechanism 930 may cause the other pulleys to rotate as the rotating drive mechanism 930 is rotated by the pulley rotated by the motor. By doing such, the wipers 910, 920 may both move towards from a center of the housing window 440 and away from the lateral edges 442, 444 of the housing window in the directions of arrows 992, 994, respectively. Eventually, wipers 910, 920 may be positioned as shown in FIG. 9. As such, the wiper blades may be moved away from one another towards an adjacent lateral edge of the housing window. Again, as an example, the wipers may each move around 180-200 mm, or more or less, towards the center of the housing window when the housing window is around 400 mm.

In some instances, a single pulley may be positioned on a side of the housing window in place of a pair of pulleys. For instance, and as shown in the example wiper system 900 FIG. 9, a single pulley 940 may replace a pair of pulleys (for instance, pulleys 840, 846 or pulleys 740, 746) adjacent to lateral edge 442. The single pulley 940 may rotate a rotating drive mechanism 930, which may correspond to any of rotating drive mechanisms 640, 730, 830, around the housing window to push and/or pull one or two wipers 910, 920 (shown in FIG. 9) across the housing window 440. Wipers 910, 920, may correspond to any of wipers 310, 320, 500, 720, 720, 810. A pair of pulleys 942, 944, which may correspond to pulleys 842, 844 or pulleys 742, 744, may be positioned adjacent to an opposite lateral edge, here lateral edge 444. The pulleys 842, 844 may direct the rotating drive mechanism 930 around the lateral edge 444. In some instances, two larger pulleys may be used in place of two pairs of pulleys. For instance, pulleys 942 and 944 may be replaced by a pulley corresponding to pulley 940. The wipers 910, 920 may be connected to the rotating drive mechanism via the wiper arm 912 and/or may be connected to a linear bearing, similar to linear bearings 630, 632, which is connected to the rotating drive mechanism.

As shown in FIG. 9, the rotating drive mechanism 930 is wrapped around at least a portion of a collection of pulleys 940, 942, 944 such that a portion 950 of the rotating drive mechanism is positioned in across a top 446 of the housing window 440 and another portion 952 of the rotating drive mechanism is positioned in across a bottom 448 of the housing window 440. For an example, as shown in FIG. 9, portions 950 and 952 may be arranged parallel to one another. One of the wipers, here wiper 910 may be attached to the rotating drive mechanism 930 via wiper arm 912 at a position below the bottom 448, and another of the wipers, here wiper 920, may be attached to the rotating drive mechanism via wiper arm 922 at a position above the top 446.

A motor (not shown, but which may be configured similarly to any of motors 610, 770, 870) may drive one of the pulleys, here pulley 940, in a first direction, depicted by arrow 980. This may cause causing the rotating drive mechanism 930, and the other pulleys 942, 944, to rotate in the first direction. In this regard, a friction force generated between the pulley 940 being rotated by the motor and the rotating drive mechanism 930 may cause the other pulleys to rotate as the rotating drive mechanism 930 is rotated by the pulley rotated by the motor. By doing such, the wipers 910, 920 may both move away from a center of the housing window 440 and towards the lateral edges 442, 444 of the housing window in the directions of arrows 982, 984, respectively. Eventually, wiper 910 may be positioned in the dashed line area 986, wiper 920 may be positioned in the dashed line area 988. This motion may move, and in some cases clear, contaminants on the housing window. As such, the wiper blades may be moved away from one another towards an adjacent lateral edge of the housing window. As an example, the wipers may each move around 180-200 mm, or more or less, away from the center of the housing window when the housing window is around 400 mm.

Thereafter the motor may drive one of the pulleys, here pulley 940, in a second direction, depicted by arrow 990. This may cause causing the rotating drive mechanism 930, and the other pulleys 942, 944 to rotate in the second direction. In this regard, a friction force generated between the single pulley 940 being rotated by the motor and the rotating drive mechanism 930 may cause the other pulleys to rotate as the rotating drive mechanism 930 is rotated by the pulley rotated by the motor. By doing such, the wipers 910, 920 may both move towards from a center of the housing window 440 and away from the lateral edges 442, 444 of the housing window in the directions of arrows 992, 994, respectively. Eventually, wipers 910, 920 may be positioned as shown in FIG. 9. As such, the wiper blades may be moved away from one another towards an adjacent lateral edge of the housing window. This motion may move, and in some cases clear, contaminants on the housing window. Again, as an example, the wipers may each move around 180-200 mm, or more or less, towards the center of the housing window when the housing window is around 400 mm.

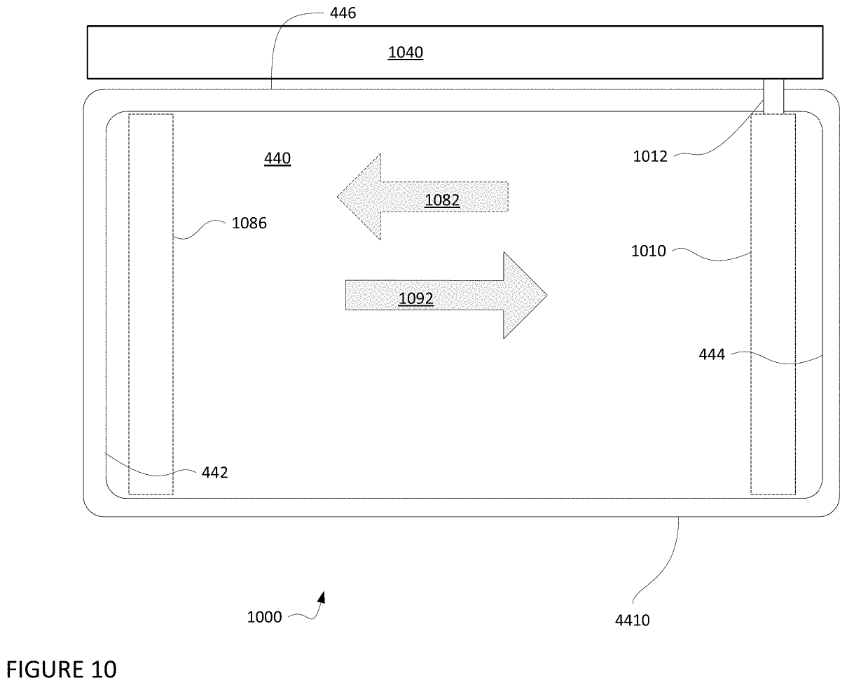

In some instances, rather than a plurality of pulleys, a screw drive may be used. For instance, and as shown in the example wiper system 1000 of FIG. 10, a screw drive system 1040 is adjacent to the top 446. Alternatively, screw drive may be adjacent to lateral edges 442, 444 or bottom 448. The screw drive system 1040 may drive a wiper 1010 across the housing window 440. Wiper 1010 may correspond to any of wipers 310, 320, 500, 720, 720, 810, 910, 920. The wiper 1010 may be connected to the screw drive system 1040 via the wiper arm 1012.

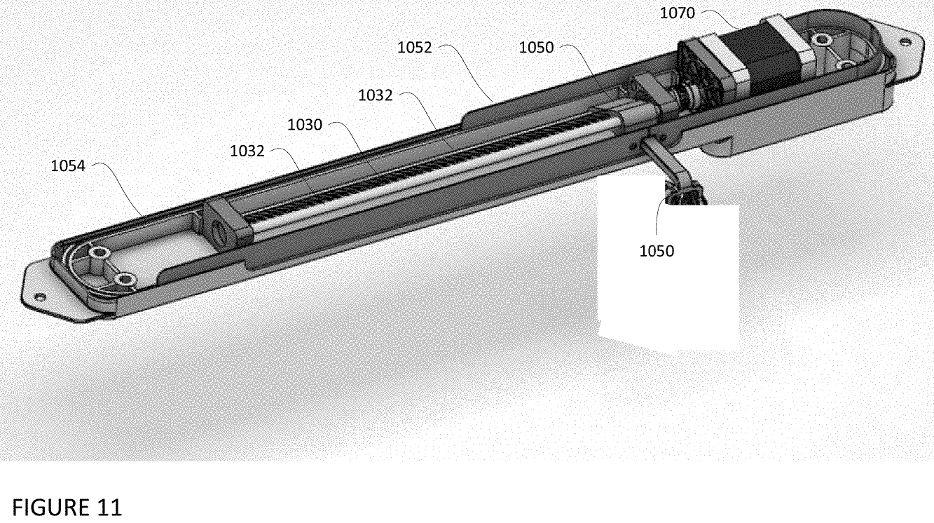

FIG. 11 is a cutaway details view of the screw drive system 1040. In this example, the screw drive may include a motor 1070 which may be a small electric motor. The motor 1070 is attached to a lead screw 1030. A wiper arm carrier 1050 is arranged with threading (not shown) in order to ride along the lead screw 1030. The screw drive system 1040 may also include one or more guide rods 132 along which the wiper arm carrier 1050 may slide. In addition, the screw drive system 1040 may include a seal 1052 placed in a track 1054. The wiper arm carrier is arranged through the seal in order to maintain a seal around the wiper arm carrier to prevent contaminants from passing into a housing of the screw drive system 1040. In this example, the wiper arm carrier and the wiper arm may be an integral piece. Alternatively, the wiper arm may be snapped, clipped, or fixed by fasteners to the wiper arm carrier.

The motor 1070 may be configured to rotate the lead screw 1030 in a first direction, for instance, clockwise (or counter clockwise). This may cause the wiper arm carrier 1050 (shown in FIG. 10), to move along the lead screw 1030 in the direction of arrow 1082 (shown in FIG. 10). Because the wiper arm carrier 1050 is arranged through the seal, the wiper arm carrier may also pull the seal along the track. The wiper 1010 may also be pulled along by the wiper arm carrier 1050 via the wiper arm 1012. The wiper 1010 may then move across the housing window 440 and towards the lateral edge 442 in the directions of arrow 1082. Eventually, wiper 1010 may be positioned in the dashed line area 1086. This motion may move, and in some cases clear, contaminants on the housing window.

Thereafter the motor may rotate the lead screw 1030 in a second direction, opposite of the first direction, for instance, counter clockwise (or clockwise). This may cause causing the wiper arm carrier 1050 to move along the lead screw 1030 in the direction of arrow 1092 (shown in FIG. 10). By doing such, the wiper 1010 may move towards the lateral edge 444 of the housing window in the direction of arrow 1092. Eventually, the wiper 1010 may be positioned as shown in FIG. 10. This motion may move, and in some cases clear, contaminants on the housing window.

Although not shown, each of the aforementioned wiper systems may also include one or more spraying systems. Each spraying system may be configured to provide a spray of cleaning solution and/or water in order to better facilitate movement and removal of contaminants from the sensor window.

Each motor in the examples described herein may be configured to drive the one or more wiper or wipers at a range of speeds according to various patterns. As an example, the motors may control the wipers in order to move at a first speed when passing through the fields of view 412, 422, 432 of the internal sensor components 410, 420, 430, respectively. This first speed may be determined to be somewhere between a maximum amount of time the wiper blade is able to pass through each of the fields of view (for instance, no more than 140 ms or more or less) and a limit of how fast the wiper blade is able to travel smoothly across the housing window and move (for instance, out of the fields of view of any internal sensor components), and in some cases clear, contaminates. For example, if the wiper blade travels too quickly, the wiper blade may tend to skip, drag or bounce on the window, so the limit on the speed should be some point before this is likely to occur. Once the wiper blade is outside of and/or beyond the fields of view 412, 422, 432 of the internal sensor components 410, 420, 430, respectively, the wiper blade may be slowed down or stopped for a period of time before the wiper blade passes back through the fields of view of the internal sensor components.

This period of time may be determined based on both a minimum amount of time as well as an amount of contaminants and/or rate of buildup of those contaminants on the sensor window. This minimum amount of time may be selected in order to allow each given one of the internal sensor components to capture sufficient sensor data, such as 400-500 ms or more or less, before the field of view that given one of the internal sensor components is again blocked by the wiper blade. If there are greater amounts of contaminants on the sensor window and/or a higher rate of buildup of those contaminants, the period of time may be a first period of time that is generally shorter (but not shorter than the minimum amount of time). If there are lesser amounts of contaminants on the sensor window and/or a slower rate of buildup of those contaminants, the period of time may be a second period of time that is generally longer or at least longer than the first period of time. In order to detect contaminants on the housing window 440, sensor data from the internal sensor components and or one or more additional sensors placed in proximity to the housing window. The sensor data from any of the aforementioned sensors may be used to automatically determine when to operate the wiper system and at what speed. In this regard, the additional sensors, such as a moisture sensor or cameras may monitor the sensor housing for buildup of contaminants. These sensors may be incorporated into the perception system 172. Sensor data from these sensors may be processed by the perception system 172 and/or computing devices 110, and used to make driving decisions for the vehicle when operating the vehicle in the autonomous driving mode. For instance, sensor data which indicates that a sensor is occluded may be discarded. In addition, upon a predetermined threshold of buildup of contaminants occurring, the perception system 172 and/or computing devices 110 may send a signal to the motor of any of the wiper systems 300, 700, 800, 900 to trigger the operation of the wiper system.

The features described above may allow for continued use of a sensor even when the sensor's cover becomes dirty. By doing such, the sensor may continue operation without interruption or the need for an individual to manually clean the sensor, as the wiper may continually clean the sensor housing or clean the sensor housing when needed. As such, the vehicle may continually operate in environments which produce a lot of contaminants, such as construction sites or off-road locations. Moreover, the features described herein may allow internal sensor components to provide sufficient imaging data when the sensor housing is being cleared.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description of the embodiments should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible embodiments. Further, the same reference numbers in different drawings can identify the same or similar elements.

1. A system comprising:
a sensor including a sensor housing and a housing window in the sensor housing;
a rotating drive mechanism, wherein a first portion of the rotating drive mechanism is positioned adjacent to the housing window;
a plurality of pulleys, wherein the rotating drive mechanism is wrapped around at least a portion of each one of the plurality of pulleys;
a wiper attached to the rotating drive mechanism; and
a motor, wherein the motor is configured to rotate at least one of the pulleys of the plurality of pulleys in order to cause at least the first portion of the rotating drive mechanism to rotate in a first direction, wherein upon the first portion of the rotating drive mechanism rotating in the first direction, the wiper moves across the housing window from an initial position to a second position in order to move contaminants on the housing window.

2. The system of claim 1, the motor is configured to rotate the at least one of the pulleys in order to cause at least the first portion of the rotating drive mechanism to rotate in a second direction opposite of the first direction, wherein upon the first portion of the rotating drive mechanism rotating in the second direction, the wiper moves across the housing window from the second position towards the initial position in order to move contaminants on the housing window.

3. The system of claim 1, wherein the plurality of pulleys includes at least two pulleys.

4. The system of claim 1, wherein the plurality of pulleys includes at least three pulleys.

5. The system of claim 1, wherein the sensor includes an internal sensor component having a field of view, and the wiper is configured to move the contaminants out of the field of view.

6. The system of claim 1, wherein the plurality of pulleys includes four pulleys, and each pulley of the plurality of pulleys is arranged at a corner of the housing window such that the rotating drive mechanism is arranged around outer edges of the housing window.

7. The system of claim 1, wherein the rotating drive mechanism is a belt.

8. The system of claim 1, wherein the rotating drive mechanism is a chain.

9. The system of claim 1, wherein the rotating drive mechanism is a rope.

10. The system of claim 1, further comprising:
a linear slide; and
a linear bearing mounted to the linear slide, wherein the wiper is attached to the linear slide and the linear bearing is in contact with the first portion of the rotating drive mechanism and configured to slide along the linear slide as the first portion of the rotating drive mechanism moves.

11. The system of claim 1, further comprising a second wiper attached to the rotating drive mechanism.

12. The system of claim 11, wherein the second wiper is attached to the rotating drive mechanism adjacent to a top of the housing window and the wiper is attached to the rotating drive mechanism adjacent to a bottom of the housing window.

13. The system of claim 12, wherein the wiper and the second wiper are attached to the rotating drive mechanism such that rotation of the at least one of the plurality of pulleys in the first direction causes the wiper and the second wiper to move away from one another.

14. The system of claim 13, wherein the wiper and the second wiper are attached to the rotating drive mechanism such that rotation of the at least one of the plurality of pulleys in the first direction causes the wiper and the second wiper to move towards one another.

15. The system of claim 11, wherein the wiper and the second wiper are attached to the rotating drive mechanism such that rotation of the at least one of the plurality of pulleys in the first direction causes the wiper and the second wiper to move in a same direction.

16. The system of claim 11, wherein the wiper is attached to the rotating drive mechanism between a first pair of the plurality of pulleys.

17. The system of claim 16, wherein the second wiper is attached to the rotating drive mechanism between a second pair of the plurality of pulleys, the first pair being different from the second pair.

18. The system of claim 1, further comprising a sensor configured to detect the contaminants on the housing window.

19. The system of claim 18, further comprising a computing device configured to receive sensor data from the sensor and cause the motor to rotate the at least one of the plurality of pulleys.

20. The system of claim 19, further comprising a vehicle configured to use the sensor to operate in an autonomous driving mode.
